(19) United States
(12) Patent Application Publication
(10) Pub. No.: US 2025/0138804 A1
(43) Pub. Date: May 1, 2025

(54) OPTIMIZATION OF LIFECYCLE MANAGEMENT ACTIVITIES

(71) Applicant: Dell Products L.P., Round Rock, TX (US)

(72) Inventors: SUDHIR VITTAL SHETTY, Cedar Park, TX (US); VINAY SAWAL, Fremont, CA (US); CHRISTOPHER BAUER ATKINSON, Woodstock, GA (US); JACOB R. HUTCHESON, Pflugerville, TX (US)

(21) Appl. No.: 18/497,494

(22) Filed: Oct. 30, 2023

(51) Int. Cl. G06F 8/65; G06F 8/41; G06F 8/71

(52) U.S. Cl. CPC G06F 8/65; G06F 8/433; G06F 8/71

(57) ABSTRACT

Methods and systems for managing operations for a data processing system are disclosed. To manage operations for the data processing system, a device update graph may be generated based on software component versions and dependency data associated with a requested update to be applied to the data processing system. A reverse topological analysis may be performed, using the device update graph, in order to identify different paths through the graph and corresponding cost for traversing each of the paths. A duration of time to complete application of the update may be identified based on the corresponding cost for each of the path. The duration of time (in isolation and/or including additional update information) may be used in obtaining an update plan for the data processing system. The update plan may be used in managing operations for the data processing system.

### FIELD

Embodiments disclosed herein relate generally to data collection. More particularly, embodiments disclosed herein relate to systems and methods to manage overhead for collection of diagnostic data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating a first data flow in accordance with an embodiment.

FIG. 2B-2C shows diagrams illustrating management of operations for a data processing system in accordance with an embodiment.

FIG. 3 shows a flow diagram illustrating a method of managing operations for a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operations for a data processing system. The operation of the data processing systems may be managed by updating the data processing systems over time.

During updating, a data processing system may be taken out of production or may have limited capacity for providing computer implemented services. To manage services during updates, various blocks of time for updating different data processing systems may be reserved.

To increase the number and/or types of updates that are completed during each block of time, the dependencies of the updates may be analyzed to identify durations of time for applying various updates. The durations of time may be taken into account when selecting updates to perform during any reserved block of time.

By doing so, the efficiency of updating devices may be improved through selection of updates for performance in time blocks based on update dependencies and/or other factors.

In an embodiment, a method for managing operations for a data processing system is disclosed. The method may include obtaining a request for application of an update to the data processing system; obtaining, using the update, a device update graph; performing, using the device update graph, a reverse topological analysis to identify paths through the device update graph; identifying, for each of the paths, a cost for traversing the respective path of the paths; identifying, using the costs for the paths, a duration of time to complete the application of the update to the data processing system; obtaining, using the duration of time, an update plan for the data processing system; updating, using the update plan, the data processing system to obtain an updated data processing system; and providing, using the updated data processing system, computer implemented services.

Obtaining the device update graph may include: identifying software component versions of the application between a current software component version of the application and a different software component version of the application specified by the update, each of the software component versions of the application being different versions of application; obtaining dependency data for the software component version, the dependency data indicating requirements for each of the software component version to be installed in the data processing system nominally, and the dependency data being usable to identify an order for installation of the software component versions that will result in nominal operation of applications hosted by the data processing system after the installation; and generating the device update graph using the software component versions and the dependency data.

The device update graph may include: nodes representing the software component versions; and edges positioned between at least a portion of the nodes, the edges representing: updates between the software component versions that are allowed to be performed; dependencies of the software component versions; and corresponding costs for application of the updates between the software component versions.

The nodes and the edges may be arranged to form a directed acyclic graph, and the directed acyclic graph may be a direct graph without a closed loop of paths to traverse.

The paths may represent independent update processes to be performed as part of the update, any of the independent update processes may be performed sequentially and/or in parallel to each other, and the paths may include sub-portions of the edges of the device update graph.

Identifying the cost for traversing the respective paths may include: identifying, for one path of the paths, edges of the device update graph along the one path, each of the edges indicating a corresponding cost based on historical data for a similar configuration of the data processing system; and obtaining a summation of the cost for each of the edges along the one path, the summation of the cost indicating a period of time to update the application to each of the software component versions associated with the one path.

The update plan may also be obtained using update preferences. The update preferences may include at least one of: priority of data processing systems of a distributed system, the data processing systems competing with the data processing system for limited resources of the distributed system for applying updates to the distributed system, and the priority of each of the data processing systems indicating a relative preference for updating over other parts of the distributed system; priority of updates to be applied to the part of the distributed system, the priority of each of the updates indicating a relative preference for applying the updates over other updates of the updates; rate-limits for the updates, the rate-limits specifying maximum numbers of the updates that are to be performed per unit of time; and buffers for applying the updates, the buffers specifying additional time beyond that which is estimated to take for application of the updates, and the time estimates for the application of the updates and the buffers being used to reduce the likelihood of update processes exceeding predetermined time windows for applying the updates.

The update plan may be adapted to be completed during an update cycle window, and the update cycle window being an amount of time available to perform any number and type of updates to the data processing system.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

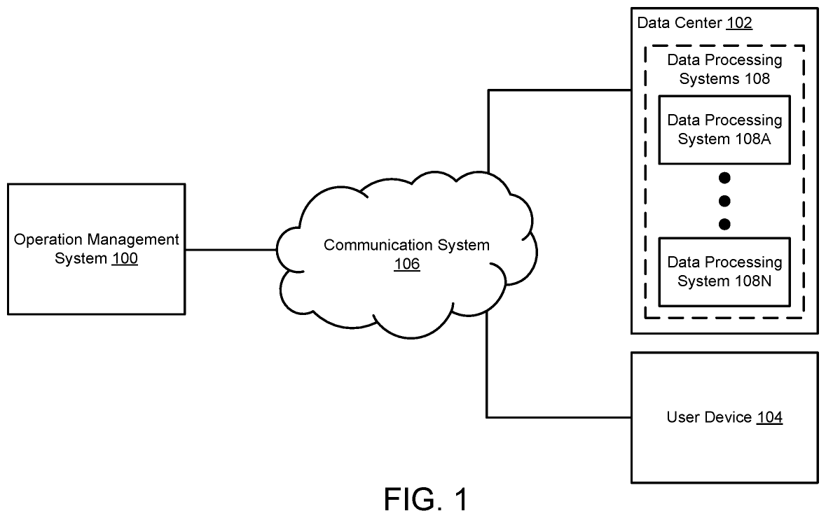

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include instant messaging services, database services, and/or any other type of service that may be implemented with a computing device.

The computer implemented services may be used to provide, for example, consumer-related services. For example, the computer implemented services may be utilized by users of a social media platform to share, receive, and/or otherwise exchange information with other users.

To provide the computer-implemented services, the system may include data center 102. Data center 102 may facilitate storage, processing, and disseminating data and applications in order to provide computer-implemented services. For example, data center 102 may aggregate user data such as videos, photos, etc. used to provide social networking and/or other types of communication services.

Data center 102 may include data processing systems 108. Data processing systems 108 may include any number of data processing systems. For example, data processing system 108 may include one data processing system (e.g., data processing system 108A) or multiple data processing systems (e.g., 108A-108N). Each data processing system of data processing systems 108 may include hardware and/or software components configured to cooperatively provide the computer-implemented services.

Over a period of time the hardware and/or software components of the data processing systems 108 may require updates in order to continue providing computer-implemented services nominally. For example, data processing system 108 may include a hard disk drive that contains a computer chip with software designed to assist the hard disk drive in performing storage and/or retrieval of data (e.g., operating system, applications, user files, etc.). In order to maintain performance of the hard disk drive, a firmware update (e.g., software update) may be initiated and applied to the computer chip of the hard disk drive.

During the application of updates, data processing system 108 may be out of production and unable to provide computer-implemented services for the duration of performing the updates. As such, a schedule for application of updates for data processing systems 108 may alleviate potential eruptions of providing computer-implemented services and/or decrease the chances of performing updates during high activity or usage of the computer-implemented services (e.g., period of time when computer-implemented services are used more frequently).

In order to implement a schedule for providing updates to data processing systems 108, a maintenance time window indicating a period of time in which one or more data processing systems may be taken out of production (e.g., to perform updates) while maintaining enough reserve capacity to meet the computing workload may be identified. For example, a server (e.g., data processing system 108) out of a fleet of servers may be taken out of production for application of a software update during the maintenance time window in which the remaining servers may have enough computing capabilities to continue performing the computer-implemented services.

As part of obtaining a schedule for application of updates to data processing systems 108, a period of time for applying the updates to data processing system 108 may be identified. However, identifying the period of time in which update(s) may be applied may present a challenge due to various factors, such as quantity of updates to be performed, performance of different systems (e.g., data processing systems with different hardware and/or software components), an ordering of the updates to be applied, etc.

For example, consider a scenario where a data processing system 108A requires multiple software updates such as a security update, storage update, and an efficiency update, in order to improve overall performance of the data processing system 108A. In some instances, the ordering in which the multiple updates are performed may influence the overall amount of time to apply the updates. For example, applying the efficiency update first and then applying the storage update second and the security update third may result in completing the updates in a lesser total time as opposed to performing the updates in a different order (e.g., applying storage update first, the efficiency update second, and the security update third). Thus, when determining a schedule for application of updates, the ordering in which to perform the updates may be necessary.

However, identifying an ordering for which to perform updates may depend on the type of update(s), performance capabilities of the data processing system (e.g., hardware and/or software components), historical data of the updates being performed within a period of time, similarity of the system performing the updates, etc. Data center 102 may lack the computing resources necessary to efficiently identify the information needed to identify the ordering for performing updates. Consequently, administrators tasked with managing the data processing systems may be unable to determine how many updates can be performed during the maintenance time window (e.g., limited amount of time scheduled for performing updates without effecting the system's ability to provide the computer-implemented services).

In general, embodiments disclosed herein may provide methods, systems, and/or devices for managing operations for a data processing system. To manage the operations for the data processing system, an update plan for the data processing system may be obtained. The update plan may indicate a period of time in which to apply the updates in an intelligent manner. To obtain the update plan for the data processing system, information regarding the maximum time-cost to perform an update may be identified and compared to the maintenance time window (e.g., allotted time to perform update) to determine if the update may be performed within the maintenance time window and if so, the number of data processing systems capable of updating within the maintenance time window may be identified. By doing so, the number of data processing systems that may be updated may be optimized and consequently, improving the overall performance of the system (e.g., collection of data processing systems performing the computer-implemented services).

To provide the above noted functionality, the system of FIG. 1 may include data center 102, operation management system 100, user device 104, and communication system 106. Each of these components is discussed below.

Operation management system 100 may manage operations of data center 102 to provide desired computer implemented services. To manage operations of data center 102, operation management system 100 may participate in operations management services provided in cooperation with data processing systems 108 of data center 102. To participate in the operations management services, operation management system 100 may (i) obtain a request for application of an update to the data processing systems of data center 102, (ii) perform a reverse topological analysis of a device update graph (e.g., generated based on the update requested), (iii) identify a duration of time to complete the application of the update to the data processing systems based on an identified costs for traversing each of the paths of the device update graph, (iv) obtain an update plan based on the duration of time, (v) provide the update plan to data center 102 for implementation of the update plan to the data processing systems (e.g., 108A-108N), and/or (vi) perform other processes to facilitate operations management of data processing systems (e.g., 108A-108N).

User device 104 may also participate in the operations management services. When participating in the update management services, user device 104 may (i) provide requests for update(s) (e.g., indicated via user input) to operation management system 100, (ii) receive information regarding the update(s), (iii) provide the computer implemented services to users (e.g., users operating user device 104), and/or (iv) perform other processes to facilitate operations management of data center 102 (e.g., data processing systems 108A-108N).

Data center 102, as noted above, may provide computer implemented services. To provide the computer implemented services, data center 102 may include any number of data processing systems (e.g., 108A-108N). Data processing systems 108 may cooperatively provide the computer implemented services. Different data processing systems may include different types of hardware and/or software components that may perform different roles (e.g., management, security, etc.) in contributing to providing computer implemented services. For example, data center 102 may implement the operations framework (e.g., update plan) to modify operation of data processing systems 108 over time. To do so, data center 102 may (i) provide information regarding software versions and dependencies to operation management system 100, (ii) receive an update plan from operation management system 100, and (iii) participate in updating of one or more data processing systems (e.g., 108A-108N) based on the update plan.

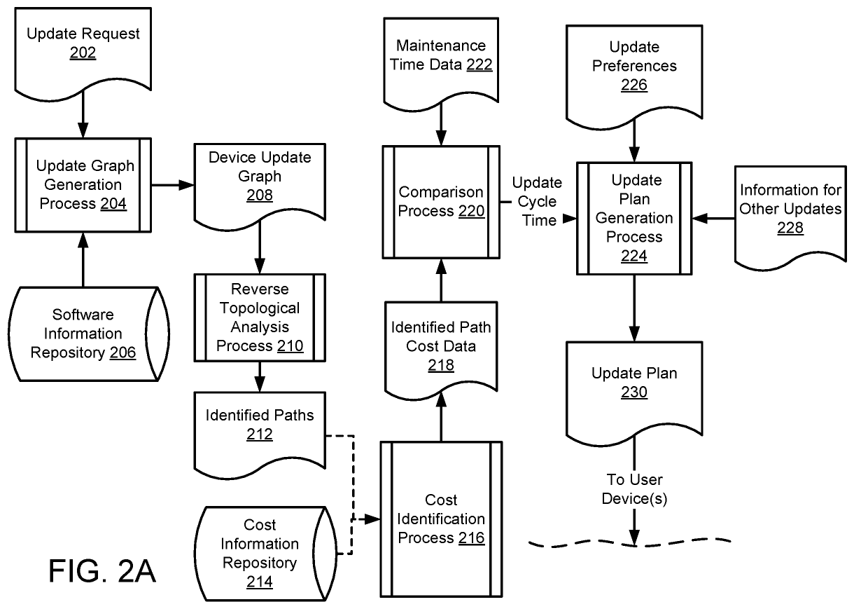

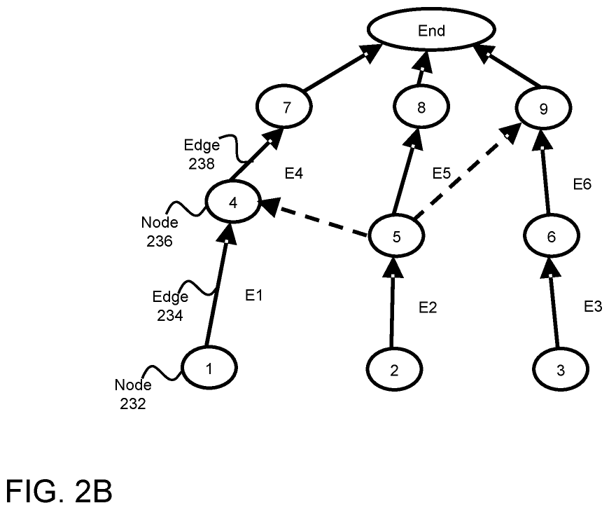

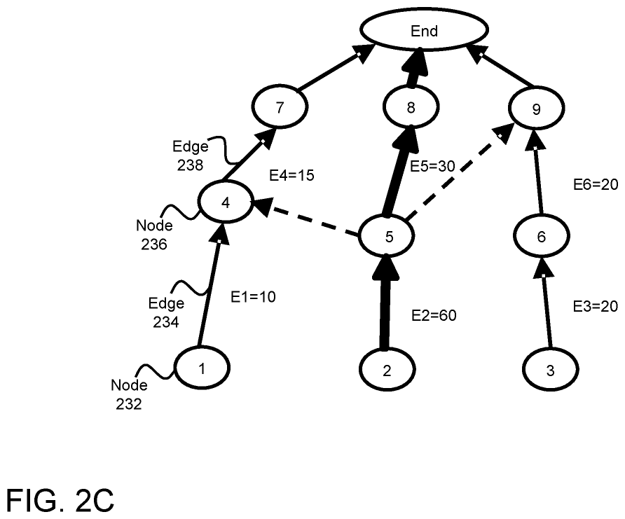

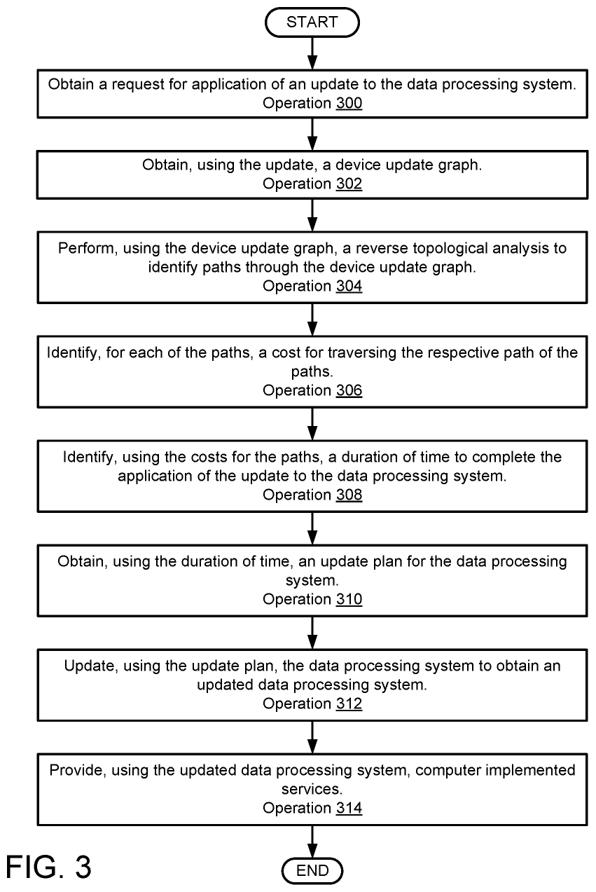

When providing their functionalities, operation management system 100, data center 102 (and/or data processing systems 108 thereof), and/or user device 104 may perform all, or a portion, of the methods and/or actions shown in FIGS. 2A-3.

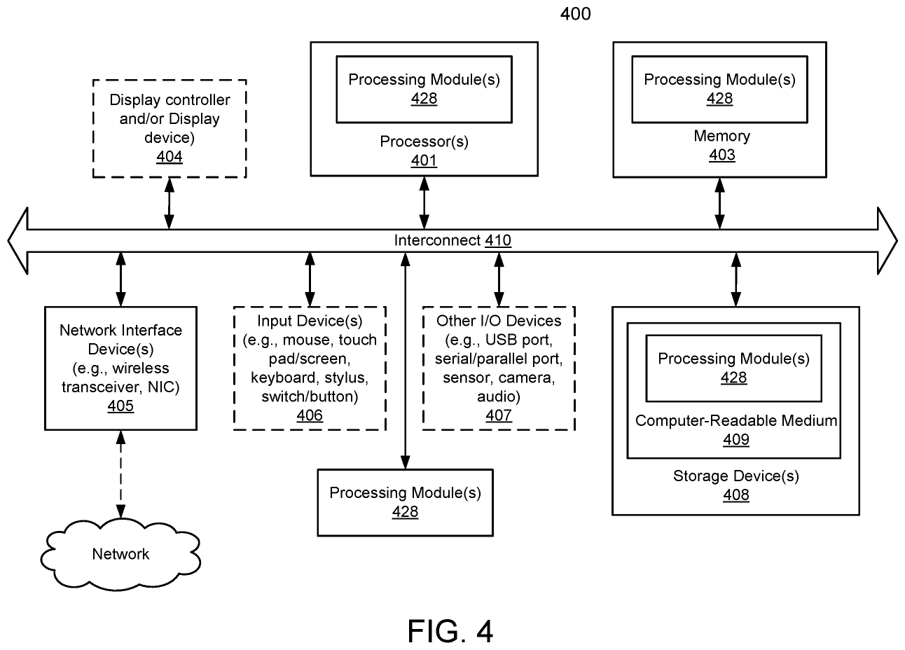

Operation management system 100, data center 102 (and/or data processing systems 108 thereof), and/or user device 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

Additionally, while illustrated in FIG. 1 with respect to a user device 104, it will be appreciated that the system may include any number of additional user devices which may each participate in providing computer implemented services.

To further clarify embodiments disclosed herein, data flow diagrams in accordance with an embodiment are shown in FIGS. 2A-2C. The data flow diagrams may illustrate how data is obtained and used within the system of FIG. 1. In these diagrams, flows of data and processing of data are illustrated using different sets of shapes. A first set of shapes (e.g., 202, 230, etc.) is used to represent data structures, a second set of shapes (e.g., 204, 220, etc.) is used to represent processes performed using and/or that generate data, and a third set of shapes (e.g., 206, 214, etc.) is used to represent large scale data structures such as databases.

Turning to FIG. 2A, a first data flow diagram illustrating data flows, data processing, and/or other operations that may be performed by the system of FIG. 1 in accordance with an embodiment is shown. The data flows, data processing, and/or other operations may be performed in obtaining an update plan for a data processing system (e.g., any of data processing system 108A-108N) in order to manage operations of the data processing system.

To obtain an update plan for a data processing system, an update request (e.g., 202) for the data processing system may be obtained. The update request may be obtained by reading the request from storage, obtaining the request from another device (e.g., user device 104), generating the request, and/or via other methods. The update request may be generated if operation management system 100 (e.g., a data processing system thereof) or data center 102 identifies a need (e.g., change in operating condition) to update operation (e.g., change configuration, add software, etc.) of a data processing system (e.g., data processing system 108A-108N shown in FIG. 1).

Once obtained, update request 202 may be ingested by update graph generation process 204. During update graph generation process 204, (i) information regarding the update (e.g., specified via update request 202) may be used to identify corresponding software information (and/or any other information necessary to generate an update graph) from software information repository 206, and (ii) generation of a device update graph (e.g., device update graph 208) may be facilitated using the software information corresponding to the update (e.g., identified via update request 202).

During update graph generation process 204, the requested update (e.g., update request 202) may be utilized in identifying software component versions of the application between a current software component version (e.g., current software version) of the application and a different software component version (e.g., desired software version specified by the update) of the application. For example, update graph generation process 204 may use an identifier of the update request (e.g., 202) as a key to perform a lookup for any number of corresponding software component versions and corresponding dependency data for the software component versions stored in software information repository 206.

Based on the identified software component versions of the application, the dependency data for the software component versions may be obtained. Each of the software component versions may include different requirements (e.g., dependency data) in order to be installed in a data processing system nominally which may be stored in a software repository (e.g., software information repository 206). For example, some of the software component versions may depend on installation of other software component versions first in order to result in nominal operation of applications hosted by the data processing system after installation.

Software information repository 206 may store any type and quantity of information regarding software versions, software dependencies, and/or any other information needed to generate a device update graph for the respective update. For example, software information repository 206 may include various software component versions (e.g., different versions of software) and dependency data for the software component versions (e.g., requirements for each of the software component versions to be installed by the data processing system nominally).

Software information repository 206 may be used in update graph generation process 204 to identify software component versions of the application and obtain the dependency data for the identified software component versions in order to obtain device update graph 208.

Device update graph 208 may include nodes and edges being arranged to form a directed acyclic graph (e.g., a direct graph without a closed loop of paths to traverse). The nodes of device update graph 208 may represent the software component versions (e.g., versions of software to be installed in order to apply the update). The edges of device update graph 208 may be positioned between, at least a portion, of the nodes, and may represent: (i) updates between the software component versions that are allowed to be performed, (ii) dependencies of the software component versions, and/or (iii) corresponding costs for application of the updates between the software component versions. For example, the corresponding costs for application of the updates between the different software component versions may include a time cost (e.g., an amount of time elapsed between the software component versions), a computation expenditure cost (e.g., an amount of computing resources to expend between performing the software component versions), and/or any other costs that may be associated with application of the updates between the software component versions.

Device update graph 208 may be used in reverse topological analysis process 210 to identify different paths through the device update graph (e.g., 208). During reverse topological analysis process 210, device update graph 208 may be subjected to graph traversal processes such as topological sorting. For example, reverse topological analysis process 210 may include performing a topological sort of the device update graph (e.g., 208) in which each node (e.g., representing software component versions of the application) is visited only after all of the dependencies are visited (e.g., dependency data for each of the software component versions) thereby identifying different sequences of software component versions to perform based on their dependencies (e.g., identified paths 212).

As a result of performing reverse topological analysis process 210, identified paths 212 may be obtained. Identified paths 212 may include sub-portions of the edges of the device update graph 208 and may represent independent update processes to be performed as part of the update. Each of the independent update processes may be performed sequentially and/or in parallel to each other. For example, identified paths 212 may include an ordering of update processes (e.g., application of software component versions) that may be performed in series and/or in parallel with each other based on the dependencies corresponding to each software component version.

Identified paths 212 may be used in cost identification process 216 to identify a cost associated with each path (e.g., independent update processes) of the device update graph (e.g., 208).

Cost identification process 216 may be performed to identify a cost associated with traversing each of the identified paths 212 (e.g., identified path cost data 218). During cost identification process 216, identified paths 212 (e.g., including information regarding the software component versions associated with each of the paths) may be analyzed in order to identify a corresponding cost (e.g., time cost) based on historical data for a similar configuration of the data processing system (e.g., 108A-108N). For example, for each path of the identified paths (e.g., 212), edges of the device update graph may be identified and used as a key to perform a look up to identify historical data (e.g., a period of time it took previously to apply the software component version) for a similar configuration (e.g., using cost information repository 214).

Cost information repository 214 may store any type and quantity of information regarding historical data of updates being applied by specific components (e.g., hardware and/or software components) of different systems. For example, cost information repository 214 may include information regarding a period of time to apply an update performed by a system that may have similar hardware components to that of the system in consideration.

Once identified, the corresponding cost for each of the edges of the respective path may be used to obtain a summation of the cost for the edges along the respective path. The summation of the cost for each path (e.g., of the identified paths 212) may be represented by identified path cost data 218.

Cost information repository 214 may include information regarding historical data and a similarity quantification (e.g., similarity between system configurations). For example, to find similar configurations for past executions, similarity scoring techniques to score the similarity of configuration using attributes such as system model, component versions, component inventory, and/or other considerations may be used. A combination of these attributes may be used to calculate a similarity score between the current configuration and historical configuration. The quantification may be a weighted sum of the similarities between different attributes. The weighted sum may be weighted using any modality (e.g., set by a subject matter expert, automated process, etc.).

Additionally, the cost for performing an update may also be estimated using a weighted moving average where T is the time taken for the k nearest neighbors determined by the above similarity analysis, or other similarity processes. The weighting may provide more weight to more recent data points.

Once obtained, update plan generation process 224 may use the information to generate an update plan (e.g., 230).

During update plan generation process 224, update preferences 226, information for other updates 228, and/or the update cycle time may be analyzed in order to obtain update plan 230. For example, update preferences 226 may be obtained by (i) receiving them from an external device (e.g., operated by an administrator), (ii) reading them from storage, and/or (iii) via any other methods.

Update preferences 226 may include, at least in part: priority of data processing systems of a distributed system (e.g., collection of data processing systems).

Thus, using the data flows and processes shown in FIG. 2A, operation of a data processing system may be automatically managed by obtaining an update plan specifying how and when updates are to be performed by the data processing system.

Turning to FIG. 2B, a diagram of an example device update graph in accordance with an embodiment is shown. In FIG. 2B, device update graph (e.g., device update graph 208 shown in FIG. 2A) may be analyzed to obtain a summation of the cost to traverse different paths (e.g., identified paths 212 shown in FIG. 2A) which may be used to identify a duration of time to complete the application of an update to a data processing system. The duration of time to complete the application of the update may be used to make decisions regarding how many data processing systems may receive the update and/or how to prioritize the limited resources of a distributed system for applying updates to the distributed system (e.g., consisting of data processing systems).

In the example topology shown in FIG. 2B, the paths (e.g., representing independent update processes) through the device update graph may consist of different nodes and edges between the respective nodes are shown. However, it will be appreciated that a distributed system in accordance with an embodiment may include different numbers of nodes and edges for different updates.

Turning to FIG. 2B, consider a scenario in which a request for application of an update to a data processing system may be obtained. Based on the update requested, current software component versions of the application and different software component versions of the application (e.g., specified by the update requested) may be identified. Information regarding the different software component versions of the application for the update (including dependency data for each of the software component versions) may be stored in a software repository (e.g., software information repository 206 shown in FIG. 2A).

As described above, performing reverse topological sorting may include traversing a graph (e.g., direct acyclic graph) to identify different paths through the graph (e.g., to reach the “end” at the top of the graph). In FIG. 2B, the paths that may be traversed through the graph may include performing independent software updates between different software component versions, represented by nodes (e.g., node 232, 236, etc.), and corresponding costs for application of the updates between the software component versions, represented by edges (e.g., edge 234, 238, etc.) in order to complete application of the update (e.g., reaching “end” at the top of the graph).

Each of the nodes of the graph, labelled as “1, 2, 3, 4, 5, 6, 7, 8 and 9”, may represent different software component versions of the application which may be identified based on the requested update (e.g., update to be applied to the data processing system). For example, node 232 may represent version 1 of software for a driver of a graphics card, and node 236 may represent version 2 of software for the driver of the graphics card. Moving from node 232 to node 236 (e.g., performing the software update process for the driver of the graphics card) may incur a cost for application of the updates between the software components versions, represented by edge 234.

Each of the edges of the graph, labelled as “E1, E2, E3, E4, E5, E6”, may represent (i) updates between the software component versions that are allowed to be performed, (ii) dependencies of the software component versions, and/or (iii) corresponding costs (e.g., time cost, computational expenditure cost, etc.) for application of the updates between the software component versions.

The independent software updates (e.g., performed as part of the update) may be performed sequentially and/or in parallel to each other which may be based on dependency data. The paths may include dependencies, indicated by dashes, between the software component versions (e.g., nodes) which may indicate requirements for each of the software component versions to be installed in the data processing system nominally. During performance of reverse topological sorting, the dependencies may be used to identify an order for installation of the software components versions (e.g., nodes) that will result in nominal operation of applications hosted by the data processing system after the installation.

For example, node “7” may represent a software update (e.g., version 2) of a video game to be applied after installation of node “4” which may represent a software update (e.g., version 2) for a driver of a graphics card in the data processing system (e.g., personal computer, gaming console, etc.). In this example, performing the update (e.g., E1) between node “1” to node “4” may depend on performing the update between node “2” to node “5” first in order for the installation of node “4” in the data processing system to be performed nominally.

Turning to FIG. 2C, a second diagram of an example device update graph in accordance with an embodiment is shown. In FIG. 2C, device update graph (e.g., device update graph 208 shown in FIG. 2A) may be analyzed to identify a duration of time to complete the application of an update to a data processing system which may be used to obtain an update plan (e.g., instructions for applying an update include prioritization of quantity of updates to be performed, prioritization of data processing systems to receive the update, etc.)

Continuing with the discussion from FIG. 2B, once a device update graph is constructed, the device update graph may be analyzed with respect to the different cost (e.g., time cost, computational expenditure cost, etc.) to traverse the paths of the device update graph. By doing so, a duration of time to complete the application of the update may be identified.

In order to identify a duration of time to complete application of the update, a cost associated with each of the paths may be identified. The corresponding costs for application of the updates between the software component versions may be represented by edges of the device update graph. For example, one of the paths of the device update graph may include starting at node 232 (e.g., version 1 of a basic input/output system (“BIOS”)), following edge 234 (e.g., E1) to reach node 236 (e.g., version 2 of BIOS). In this example, edge 234, represented by “E1”, may indicate a time cost of 25 units of time (e.g., seconds, minutes, etc.).

When performing analysis of the different paths, a cost for each path may be identified based on the edges along the respective paths. For example, a first path may include traversing from “E1”, represented as 10 units of time (e.g., seconds, minutes, etc.), to “E4”, represented as 15 units of time. To identify the cost for the first path may include performing a summation of the costs for each of the edges (e.g., E1 and E4) of the first path. For example, the summation of the cost for the first path may equal 25 units of time (e.g., seconds, minutes, etc.). The summation of the cost for each of the paths may indicate a period of time to update the application to each of the software component versions associated with the respective paths.

In order to identify the duration of time to complete the application, analysis of the summation of the cost for each of the paths through the graph may be performed. During analysis of the summation of the cost for each of the paths, the path with the highest cost (e.g., largest amount of time to apply the update) may be identified.

Continuing the above example, a second path may include traversing from “E2”, represented as 60 units of time (e.g., seconds, minutes, etc.), to “E5”, represented as 30 units of time may be summed to equal 90 units of time. A third path may include traversing from “E3”, represented as 20 units of time (e.g., seconds, minutes, etc.), to “E6”, represented as 20 units of time may be summed to equal 40 units of time. In this example, the system may identify the duration of time to complete the application to be 90 units of time based on identification of the highest cost (e.g., time cost) path being the second path.

The highest cost path (e.g. largest amount of time to traverse a path) may be used in verifying whether the path is within a maintenance time window. By doing so, the maximum amount of time to perform an update may be considered when identifying how many data processing systems may be updated within the maintenance time window thereby optimizing the number of updates to be performed for data processing systems while decreasing the likelihood that application of the updates will impact the computer implemented services being provided by the data processing systems.

As discussed above, the components of FIGS. 1-2C may perform various methods to provide process management services by identifying an inferred state of operation of the data processing system in order to manage operation of the data processing system. FIG. 3 illustrate methods that may be performed by the components of FIGS. 1-2C. In the diagram discussed below and shown in the figure, any of the operations may be repeated, performed in different orders, omitted, and/or performed in parallel with or a partially overlapping in time manner with other operations.

Turning to FIG. 3, a flow diagram illustrating a method of managing a process performed by a host device in accordance with an embodiment is shown. The method may be performed, for example, by a data processing system, a management system, a communication system, a management controller, hardware resources, and/or other components illustrated in FIGS. 1-2C.

At operation 300, a request for application of an update to the data processing system may be obtained. The request for application of the update may be obtained by (i) receiving the request from an external device via electronic communication, (ii) reading the request from storage, and/or (iii) any other methods. For example, the request may be received from a user device (e.g., user device 104 shown in FIG. 1) via electronic communication.

At operation 302, a device update graph may be obtained. The device update graph may be obtained by using the update. Obtaining the device update graph may be performed by (i) identifying software component versions of the application between a current software component version of the application and a different software component version of the application specified by the update, each of the software component versions of the application being different versions of the application, (ii) obtaining dependency data for the software component version, the dependency data indicating requirements for each of the software component version to be installed in the data processing system nominally, and the dependency data being usable to identify an order for installation of the software component versions that will result in nominal operation of applications hosted by the data processing system after the installation, and (iii) generating the device update graph using the software component versions and the dependency data.

At operation 304, a reverse topological analysis may be performed using the device update graph to identify paths through the device update graph. Performing the reverse topological analysis may be facilitated by performing an analysis of the device update graph including an analysis of nodes (e.g., representing software component versions of the application) and edges (e.g., representing updates between the software component versions, dependencies of the software component versions, and/or corresponding costs for application of the updates) which may be arranged to form a directed acyclic graph.

At operation 306, for each of the paths, a cost for traversing the respective path of the paths may be identified. The cost for traversing the respective paths may be identified by (i) identifying, for one path of the paths, edges of the device update graph along the one path, each of the edges indicating a corresponding cost based on historical data for a similar configuration of the data processing system, (ii) obtaining a summation of the cost for each of the edges along the one path, the summation of the cost indicating a period of time to update the application to each of the software component versions associated with the one path.

At operation 308, a duration of time to complete the application of the update to the data processing system may be identified using the costs for the paths. The duration of time to complete the application of the update may be identified by analyzing the costs for the paths and identifying the path with the “highest cost”. For example, each path of a reverse topological graph may represent an amount of time in order to traverse the respective path and identifying the “duration of time” to complete the application may include identifying the path that may take the largest amount of time to complete compared to the other paths.

At operation 310, an update plan for the data processing system may be obtained using the duration of time. The update plan may be obtained by (i) obtaining a maintenance time window (e.g., a predetermined time window for applying updates), (ii) comparing the duration of time and the maintenance time window to identify an update cycle time.

At operation 312, the data processing system may be updated using the update plan to obtain an updated data processing system. The data processing system may be updated by (i) providing the update plan to the data processing system, (ii)

At operation 314, computer-implemented services may be provided using the updated data processing system. The computer-implemented services may be provided by (i)

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operations for a data processing system, the method comprising:
obtaining a request for application of an update to the data processing system;
obtaining, using the update, a device update graph;
performing, using the device update graph, a reverse topological analysis to identify paths through the device update graph;
identifying, for each of the paths, a cost for traversing the respective path of the paths;
identifying, using the costs for the paths, a duration of time to complete the application of the update to the data processing system;
obtaining, using the duration of time, an update plan for the data processing system;
updating, using the update plan, the data processing system to obtain an updated data processing system; and
providing, using the updated data processing system, computer implemented services.

2. The method of claim 1, wherein obtaining the device update graph comprises:
identifying software component versions of the application between a current software component version of the application and a different software component version of the application specified by the update, each of the software component versions of the application being different versions of application;
obtaining dependency data for the software component version, the dependency data indicating requirements for each of the software component version to be installed in the data processing system nominally, and the dependency data being usable to identify an order for installation of the software component versions that will result in nominal operation of applications hosted by the data processing system after the installation; and
generating the device update graph using the software component versions and the dependency data.

3. The method of claim 2, wherein the device update graph comprises:
nodes representing the software component versions; and
edges positioned between at least a portion of the nodes, the edges representing:
updates between the software component versions that are allowed to be performed;
dependencies of the software component versions; and
corresponding costs for application of the updates between the software component versions.

4. The method of claim 3, wherein the nodes and the edges are arranged to form a directed acyclic graph, the directed acyclic graph being a direct graph without a closed loop of paths to traverse.

5. The method of claim 3, wherein the paths represent independent update processes to be performed as part of the update, any of the independent update processes being performed sequentially and/or in parallel to each other, and the paths comprising sub-portions of the edges of the device update graph.

6. The method of claim 3, wherein identifying the cost for traversing the respective paths comprises:
identifying, for one path of the paths, edges of the device update graph along the one path, each of the edges indicating a corresponding cost based on historical data for a similar configuration of the data processing system; and
obtaining a summation of the cost for each of the edges along the one path, the summation of the cost indicating a period of time to update the application to each of the software component versions associated with the one path.

7. The method of claim 3, wherein the update plan is also obtained using update preferences, the update preferences comprising at least one of:
priority of data processing systems of a distributed system, the data processing systems competing with the data processing system for limited resources of the distributed system for applying updates to the distributed system, and the priority of each of the data processing systems indicating a relative preference for updating over other parts of the distributed system;
priority of updates to be applied to the part of the distributed system, the priority of each of the updates indicating a relative preference for applying the updates over other updates of the updates;
rate-limits for the updates, the rate-limits specifying maximum numbers of the updates that are to be performed per unit of time; and
buffers for applying the updates, the buffers specifying additional time beyond that which is estimated to take for application of the updates, and the time estimates for the application of the updates and the buffers being used to reduce a likelihood of update processes exceeding predetermined time windows for applying the updates.

8. The method of claim 1, wherein the update plan is adapted to be completed during an update cycle window, and the update cycle window being an amount of time available to perform any number and type of updates to the data processing system.

9. A non-transitory machine-readable medium having instructions stored therein, which when executed by a processor, cause the processor to perform operations for managing operations for a data processing system, the operations comprising:
obtaining a request for application of an update to the data processing system;
obtaining, using the update, a device update graph;
performing, using the device update graph, a reverse topological analysis to identify paths through the device update graph;
identifying, for each of the paths, a cost for traversing the respective path of the paths;
identifying, using the costs for the paths, a duration of time to complete the application of the update to the data processing system;
obtaining, using the duration of time, an update plan for the data processing system;
updating, using the update plan, the data processing system to obtain an updated data processing system; and
providing, using the updated data processing system, computer implemented services.

10. The non-transitory machine-readable medium of claim 9, wherein obtaining the device update graph comprises:
identifying software component versions of the application between a current software component version of the application and a different software component version of the application specified by the update, each of the software component versions of the application being different versions of application;
obtaining dependency data for the software component version, the dependency data indicating requirements for each of the software component version to be installed in the data processing system nominally, and the dependency data being usable to identify an order for installation of the software component versions that will result in nominal operation of applications hosted by the data processing system after the installation; and
generating the device update graph using the software component versions and the dependency data.

11. The non-transitory machine-readable medium of claim 10, wherein the device update graph comprises:
nodes representing the software component versions; and
edges positioned between at least a portion of the nodes, the edges representing:
updates between the software component versions that are allowed to be performed;
dependencies of the software component versions; and
corresponding costs for application of the updates between the software component versions.

12. The non-transitory machine-readable medium of claim 11, wherein the nodes and the edges are arranged to form a directed acyclic graph, the directed acyclic graph being a direct graph without a closed loop of paths to traverse.

13. The non-transitory machine-readable medium of claim 11, wherein the paths represent independent update processes to be performed as part of the update, any of the independent update processes being performed sequentially and/or in parallel to each other, and the paths comprising sub-portions of the edges of the device update graph.

14. The non-transitory machine-readable medium of claim 11, wherein identifying the cost for traversing the respective paths comprises:
identifying, for one path of the paths, edges of the device update graph along the one path, each of the edges indicating a corresponding cost based on historical data for a similar configuration of the data processing system; and
obtaining a summation of the cost for each of the edges along the one path, the summation of the cost indicating a period of time to update the application to each of the software component versions associated with the one path.

15. The non-transitory machine-readable medium of claim 11, wherein the update plan is also obtained using update preferences, the update preferences comprising at least one of:
priority of data processing systems of a distributed system, the data processing systems competing with the data processing system for limited resources of the distributed system for applying updates to the distributed system, and the priority of each of the data processing systems indicating a relative preference for updating over other parts of the distributed system;
priority of updates to be applied to the part of the distributed system, the priority of each of the updates indicating a relative preference for applying the updates over other updates of the updates;
rate-limits for the updates, the rate-limits specifying maximum numbers of the updates that are to be performed per unit of time; and
buffers for applying the updates, the buffers specifying additional time beyond that which is estimated to take for application of the updates, and the time estimates for the application of the updates and the buffers being used to reduce a likelihood of update processes exceeding predetermined time windows for applying the updates.

16. A data processing system, comprising:
a processor; and
a memory coupled to the processor to store instructions, which when executed by the processor, cause the processor to perform operations for managing data collection for managed devices and unmanaged devices, the operations comprising:
obtaining a request for application of an update to the data processing system;
obtaining, using the update, a device update graph;
performing, using the device update graph, a reverse topological analysis to identify paths through the device update graph;
identifying, for each of the paths, a cost for traversing the respective path of the paths;
identifying, using the costs for the paths, a duration of time to complete the application of the update to the data processing system;
obtaining, using the duration of time, an update plan for the data processing system;
updating, using the update plan, the data processing system to obtain an updated data processing system; and
providing, using the updated data processing system, computer implemented services.

17. The data processing system of claim 16, wherein obtaining the device update graph comprises:
identifying software component versions of the application between a current software component version of the application and a different software component version of the application specified by the update, each of the software component versions of the application being different versions of application;
obtaining dependency data for the software component version, the dependency data indicating requirements for each of the software component version to be installed in the data processing system nominally, and the dependency data being usable to identify an order for installation of the software component versions that will result in nominal operation of applications hosted by the data processing system after the installation; and
generating the device update graph using the software component versions and the dependency data.

18. The data processing system of claim 17, wherein the device update graph comprises:
nodes representing the software component versions; and
edges positioned between at least a portion of the nodes, the edges representing:
updates between the software component versions that are allowed to be performed;
dependencies of the software component versions; and
corresponding costs for application of the updates between the software component versions.

19. The data processing system of claim 18, wherein the nodes and the edges are arranged to form a directed acyclic graph, the directed acyclic graph being a direct graph without a closed loop of paths to traverse.

20. The data processing system of claim 18, wherein the paths represent independent update processes to be performed as part of the update, any of the independent update processes being performed sequentially and/or in parallel to each other, and the paths comprising sub-portions of the edges of the device update graph.
